(19) United States
(12) Patent Application Publication
(10) Pub. No.: US 2013/0072127 A1
(43) Pub. Date: Mar. 21, 2013

(54) METHOD FOR TESTING HANDHELD ELECTRONIC DEVICE

(71) Applicants: CHUN-LIN HUANG, TAIPEI CITY (TW); CHING-FENG HSIEH, TAIPEI CITY (TW)

(72) Inventors: CHUN-LIN HUANG, TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/288,993

(22) Filed: Nov. 4, 2011

(30) Foreign Application Priority Data
Sep. 16, 2011 (TW) 100133339

(51) Int. Cl. H04W 24/00

(52) U.S. Cl. 455/67.11

(57) ABSTRACT

A method for testing handheld electronic device is for use in testing the power consumption level of a handheld electronic device equipped with an open operating platform. The method involves configuring, in the open operating platform, a radio communication unit and a display unit of the handheld electronic device; configuring the radio communication unit such that the radio communication unit can receive a data signal; adjusting controllably brightness of the display unit; and comparing, after a predetermined time period of control, an initial power level and a current power level of a battery in the handheld electronic device to evaluate power consumption of the handheld electronic device.

### CROSS-REFERENCE TO RELATED APPLICATION

This non-provisional application claims priority under 35 U.S.C. §119(a) on Patent Application No(s). 100133339 filed in Taiwan, R.O.C. on Sep. 16, 2011, the entire contents of which are hereby incorporated by reference.

### FIELD OF TECHNOLOGY

The present invention relates to a method for testing a handheld electronic device, in particular to a power consumption testing method for testing a battery of the handheld electronic device.

### BACKGROUND

Nowadays, more and more handheld electronic devices are equipped with an open operating platform. Testers can connect a handheld electronic device to the Internet through a mobile communication device and a wireless network device installed in the handheld electronic device to obtain a large quantity of network data. Among these data, multimedia data are most welcome by the testers. In addition, a large number of application programs provided by the open operating platform can be used for playing the multimedia data. However, the multimedia data are played by performing high-speed computation by a micro-processing unit installed in the handheld electronic device, and the high-speed computation will increase the power consumption of a battery. As a result, power consumption is a very important issue for battery sustainability of a handheld electronic device.

If manufacturers want to know about the power consumption of hardware devices, a brightness test of a display unit which is controlled at full-brightness, full-darkness or half-brightness is performed within a specific time period to calculate the total power consumption during the specific time period. However, there are many different ways of using the handheld electronic device by the testers (not just adjusting the brightness of the display unit only), and it is an urgent and important subject to find a solution for evaluating the power consumption of the battery more accurately.

Therefore, it is imperative to simulate a method for testing a handheld electronic device actually used by the testers.

### SUMMARY

It is a primary objective of the present invention to provide a method for testing a handheld electronic device, wherein a power consumption condition of a battery of the handheld electronic device is obtained and provided to a tester as an effective evaluation of the power management for the handheld electronic device and the battery.

Another objective of the present invention is to base on the aforementioned testing method to control different signal types (including a stream signal or a data signal) received by a wireless communication unit and display the data type according to the display brightness of different display units to simulate the status of using the handheld electronic device by a tester accurately.

To achieve the aforementioned and other objectives, the present invention provides a method for testing a handheld electronic device applied for testing the handheld electronic device equipped with an open operating platform, and a wireless communication unit and a display unit of the handheld electronic device being controlled through the open operating platform to perform a power consumption test of a battery of the handheld electronic device, comprising the steps of: (a) obtaining an initial power level of the battery of the handheld electronic device; (b) transmitting a wireless communication testing instruction to the wireless communication unit, such that the wireless communication unit receives a data signal through a wireless communication channel, and transmitting a brightness control instruction to the display unit to produce a predetermined display brightness according to he brightness control instruction; (c) continuing executing the testing procedure of Step (b) for a predetermined time period, and terminating the testing procedure of Step (b); (d) obtaining a current power level of the battery of the handheld electronic device; and (e) comparing the initial power level with the current power level to obtain a power consumption condition of the handheld electronic device.

Unlike the prior art, the method for testing a handheld electronic device in accordance with the present invention simulates the testing environment for a tester using the handheld electronic device to evaluate the actual power consumption condition of the handheld electronic device. In addition, the present invention controls the wireless communication unit installed in the handheld electronic device in a wireless communication transmission such as a wireless wide area network (WWAN), a wireless local area network (WLAN) or a wireless personal area networks (WPAN) and a data signal (such as a multimedia stream video data or webpage data signal) to carry out wireless data transmission, and displays the data signal by setting the display brightness of the display unit to obtain the power consumption condition of the handheld electronic device.

### BRIEF DESCRIPTION

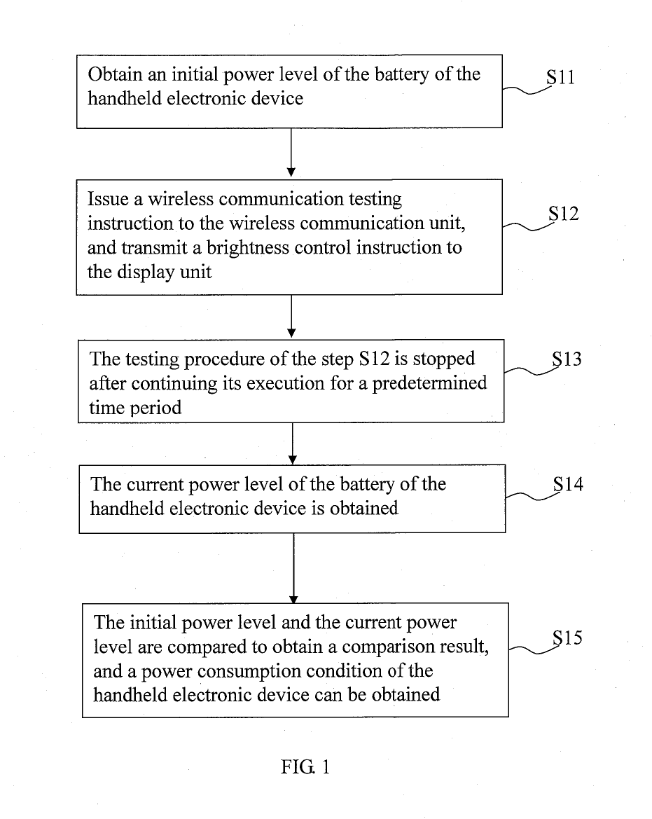

FIG. 1 is a flow chart of a method for testing a handheld electronic device in accordance with a first preferred embodiment of the present invention; and

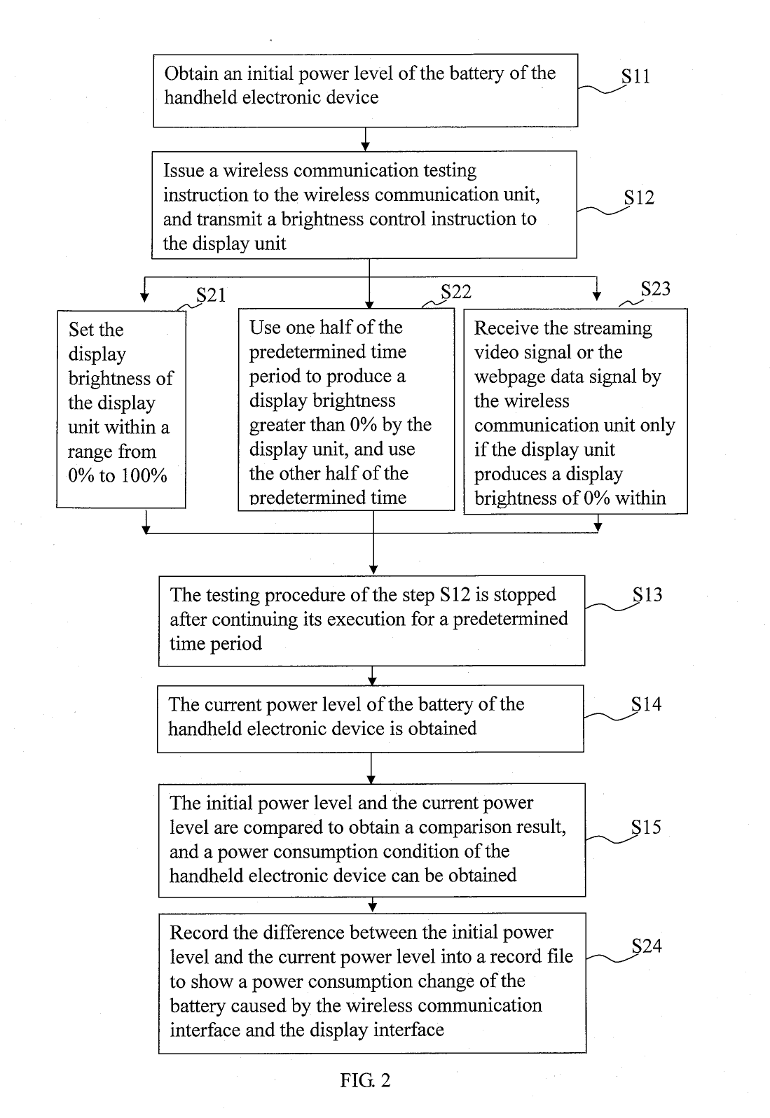

FIG. 2 is a flow chart of a method for testing a handheld electronic device in accordance with a second preferred embodiment of the present invention.

### DETAILED DESCRIPTION

The objects, characteristics and effects of the present invention will become apparent with the detailed description of the preferred embodiments and the illustration of related drawings as follows.

With reference to FIG. 1 for a flow chart of a method for testing a handheld electronic device in accordance with the first preferred embodiment of the present invention, the handheld electronic device is equipped with an open operating platform such as an Android operating platform. In addition, a power consumption testing program is installed on the open operating platform, and the power consumption testing program is executed to generate a plurality of testing instructions. The testing instruction is provided for controlling a wireless communication unit and a display unit installed in the handheld electronic device to carry out a power consumption test for the battery of the handheld electronic device.

Wherein, the testing method comprises the following steps. In Step S11, an initial power level of the battery of the handheld electronic device is obtained. For example, the current power level of the battery is recorded before the power consumption testing program is executed. At this moment, the current power level is defined as the initial power level.

In Step S12, a wireless communication testing instruction is issued to the wireless communication unit, such that the wireless communication unit receives the data signal through a wireless communication channel and transmits a brightness control instruction to the display unit to produce expected display brightness according to the brightness control instruction.

For example, the wireless communication unit can be a unit in compliance with a wireless communication protocol/specification including Code Division Multiple Access 2000 (CDMA2000), Code Division Multiple Access One (cdmaOne), General Packet Radio Service (GPRS), Global System for Mobile Communications (GSM), Universal Mobile Telecommunications System (UMTS), Wireless Fidelity (WiFi), and Worldwide Interoperability for Microwave Access (WiMax), and the handheld electronic device equipped with the wireless communication unit can perform wireless communication in a wireless communication environment (such as WWAN, WLAN and WPAN), so that the handheld electronic device can receive multimedia streaming video signals through the wireless connection such as the Internet, or receive/transmit webpage data signals, such as a data search on a webpage.

In a preferred embodiment, the wireless communication testing instruction includes a default website, so that when the wireless communication unit receives the wireless communication testing instruction, the wireless communication unit can be used for receiving the streaming video signal according to the default website or connecting to a webpage corresponding to the website to simulate and generate the webpage data signal. Wherein, the webpage data signal repeatedly simulates a webpage data signal produced between at least two web pages, when a user connects to the website.

In addition, the display unit can be a liquid crystal display unit or an organic light emitting display unit for displaying the streaming video signal or the webpage data signal. For example, if the display unit is a liquid crystal display unit, the display unit includes an LCD panel and a backlight unit, and the aforementioned signals are displayed by the LCD panel, and the brightness unit provides the display brightness to the LCD panel to display the signals; and if the display unit is an organic light emitting display unit, the aforementioned backlight unit is not required, so that the brightness control instruction controls the organic light emitting display unit directly, and drives the organic light emitting display unit to produce the display brightness spontaneously.

In Step S13, the testing procedure as described in the step S12 is stopped after continuing its execution for a predetermined time period. For example, the predetermined time period is equal to 8 hours, so that the power consumption testing program will end the testing procedure after the predetermined time period is completed.

In a preferred embodiment, the testing method is to use one half of the predetermined time period for receiving the streaming video signal or the webpage data signal, and stop receiving the streaming video signal or the webpage data signal in the other half the predetermined time period. In other words, an intermittent testing method can be used within the predetermined time period, wherein some time is used for transmitting the wireless communication testing instruction and the brightness control instruction that consumes the battery power of the handheld electronic device, and the remaining time is used for not performing a power consumption test to the battery. This method can simulate the actual situation of a tester using the handheld electronic device more accurately.

In Step S14, the current power level of the battery of the handheld electronic device is obtained. For example, the power consumption testing program obtains the remaining power level (which is also the aforementioned current power level) by a power consumption test within the predetermined time period, after the step S13 is completed.

In Step S15, the initial power level and the current power level are compared to obtain a comparison result, and a power consumption condition of the handheld electronic device can be obtained. For example, the initial power level is equal to 5 volts before the test takes place, and after the power consumption test takes place for a predetermined time period (such as 8 hours), the initial power level drops from 5 volts to 2 volts (which is the current power level). In other words, the battery has consumed a power of 3 volts, which is equal to 60% of the original power level, or the average power consumption is 0.375 volt per hour.

With reference to FIG. 2 for a flow chart of a method for testing a handheld electronic device in accordance with the second preferred embodiment of the present invention, besides the original testing procedure, the step S12 further comprises a step S21 of setting the display brightness of the display unit within a range from 0% to 100% by the power consumption testing program, wherein 0% indicates the minimum of the display brightness which is a full-darkness state, and 100% indicates the maximum of the display brightness which is a full-brightness state. For example, in the display unit containing the LCD panel and the backlight unit, the brightness control instruction controls the backlight unit to produce the display brightness within a range from 0% to 100%, wherein the display brightness 0% indicates the minimum of the display brightness which is a full-darkness state or the backlight unit will not have any power loss. On the other hand, the display brightness of 100% indicates the maximum of the display brightness which is a full-brightness state, or the backlight unit has a power loss. When the display brightness falls within a range from 0% to 100%, it shows that the power consumption is a proportion of the maximum value of the display brightness.

In another preferred embodiment, if the display unit is an organic light emitting display unit, the brightness control instruction controls the organic light emitting display unit directly to produce the display brightness within a range from 0% to 100%.

In another preferred embodiment, the step S12 further comprises a step S22 of using one half of the predetermined time period to produce a display brightness greater than 0% by the display unit, and using the other half of the predetermined time period to produce a display brightness of 0% by the display unit. For example, the brightness control instruction drives the display unit to produce the display brightness of 66% in one half of the predetermined time period, and a fully-darkness state exists in the other half of the predetermined time period. In the same conditions, the display unit having the display brightness of 66% consumes less power than the display unit having the display brightness of 100% (which is fully bright).

In a further preferred embodiment, the step S12 further comprises a step S23 of receiving the streaming video signal or the webpage data signal by the wireless communication unit only if the display unit produces a display brightness of 0% within the predetermined time period. In other words, in this preferred embodiment, the wireless communication unit just performs the power consumption test for the battery, but not for the power consumption of the display unit.

In addition, the method for testing a handheld electronic device further comprises a step S24 of recording the difference between the initial power level and the current power level into a record file to show a power consumption change of the battery caused by the wireless communication unit and the display unit. In addition, the record file also includes recorded testing time and testing conditions (such as setting to an on/off state of the wireless communication unit, configuring the wireless communication unit to receive the data signal, or setting the display brightness of the display unit), so that the tester can analyze and evaluate the power consumption of the batter of the handheld electronic device through the record file.

Therefore, the method for testing a handheld electronic device of the present invention simulates the testing environment for a tester using the handheld electronic device to evaluate the actual power consumption condition of the handheld electronic device. Wherein, the present invention also takes the testing conditions of the wireless communication unit and the display unit of the handheld electronic device into consideration to obtain power consumption condition when the tester actually uses the handheld electronic device.

While the invention has been described by means of specific embodiments, numerous modifications and variations could be made thereto by those skilled in the art without departing from the scope and spirit of the invention set forth in the claims.

What is claimed is:

1. A method for testing a handheld electronic device, applied for testing the handheld electronic device equipped with an open operating platform, and a wireless communication unit and a display unit of the handheld electronic device being controlled through the open operating platform to perform a power consumption test of a battery of the handheld electronic device, comprising the steps of:
(a) obtaining an initial power level of the battery of the handheld electronic device;
(b) transmitting a wireless communication testing instruction to the wireless communication unit, such that the wireless communication unit receives a data signal through a wireless communication channel, and transmitting a brightness control instruction to the display unit to produce a predetermined display brightness according to the brightness control instruction;
(c) continuing executing the testing procedure of the step (b) for a predetermined time period, and terminating the testing procedure of the step (b);
(d) obtaining a current power level of the battery of the handheld electronic device; and
(e) comparing the initial power level with the current power level to obtain a power consumption condition of the handheld electronic device.

2. The method for testing a handheld electronic device as recited in claim 1, wherein the data signal received in the step (b) is a streaming video signal or a webpage data signal.

3. The method for testing a handheld electronic device as recited in claim 2, wherein the step (b) uses one half of the predetermined time period to receive the streaming video signal or the webpage data signal and stops receiving the streaming video signal or the webpage data signal within the other half of the predetermined time period.

4. The method for testing a handheld electronic device as recited in claim 3, wherein the predetermined time period is equal to 8 hours.

5. The method for testing a handheld electronic device as recited in claim 2, wherein the display brightness of the display unit described in the step (b) falls within a range from 0% to 100%, and 0% indicates the minimum of the display brightness which is a full-darkness state, and 100% indicates the maximum of the display brightness which is a full-brightness state.

6. The method for testing a handheld electronic device as recited in claim 5, wherein the step (b) uses one half of the predetermined time period to produce a display brightness higher than 0% by the display unit and the other half of the predetermined time period to produce a display brightness of 0% by the display unit.

7. The method for testing a handheld electronic device as recited in claim 6, wherein the predetermined time period is equal to 8 hours.

8. The method for testing a handheld electronic device as recited in claim 6, wherein the wireless communication unit receives the streaming video signal or the webpage data signal in the step (b) only in the predetermined time period when the display unit produces a display brightness of 0%.

9. The method for testing a handheld electronic device as recited in claim 1, wherein the Step (e) further comprises recording the difference between the initial power level and the current power level into a record file to show a power consumption change of the battery caused by the wireless communication unit and the display unit.

10. The method for testing a handheld electronic device as recited in claim 1, wherein the open operating platform is an Android operating platform.
